(19) United States
(12) Patent Application Publication
(10) Pub. No.: US 2001/0027234 A1
(43) Pub. Date: Oct. 4, 2001

(54) Radiation-curable binders of low additive content

(75) Inventors: Horst Binder, Lampertheim (DE); Petra Neumann, Bohl-Iggelheim (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Aktiengesellschaft, Ludwigshafen (DE)

(21) Appl. No.: 09/824,762

(22) Filed: Apr. 4, 2001

(30) Foreign Application Priority Data
Apr. 4, 2000 (DE) 10016652.0

(51) Int. Cl. C08F 8/00

(52) U.S. Cl. 525/107

(57) ABSTRACT

The invention relates to transparent, undiscolored and uncrosslinked, radiation-curable binders of low additive content, obtainable by polymer-analogous reaction of epoxy-functional (meth)acrylate copolymers (A) with an unsaturated monocarboxylic acid (B), the reaction a) of the copolymer (A) taking place with at least 2 equivalents of the carboxylic acid (B), b) in the absence of reaction accelerators and inhibitors, c) in a continuously operated reactor, d) without solvent, e) at from 130 to 170° C., f) with a degree of conversion of at least 90% within an average residence time which is as short as possible but sufficient, and which is below 13 to 22 minutes. The reaction products contain virtually no byproducts and are advantageous binders for clearcoat materials and powder coating materials.

The invention relates to transparent, undiscolored, and uncrosslinked radiation-curable binders of low additive content, prepared by polymer-analogous reaction of an epoxy-functional acrylic copolymer with an olefinically unsaturated carboxylic acid.

Binders of the abovementioned kind are known per se. For example, it is known from the patent application WO 93/25590 that polymers containing unsaturated side groups may be prepared for topcoat materials in the automotive industry by subjecting a copolymer A containing monomers (a) containing an epoxy, carboxyl, hydroxyl or isocyanato group in copolymerized form to polymer-analogous reaction with a monomer (B) containing a functional group which is able to react with the functional group of the copolymer (A). Examples of monomers B were (meth)acrylic acid, glycidyl (meth)acrylate, allyl glycidyl ether, hydroxyethyl (meth)acrylate or maleic acid. For the batchwise polymer-analogous reaction, the functional monomers B were introduced dropwise at from 50 to 150° C. with stirring into solutions of the copolymers A with a strength of approximately 50%, in the presence of a reaction accelerator for the reaction of the functional groups and in the presence of a polymerization inhibitor such as a hydroquinone compound. The mixture was then held at the stated temperature with stirring for several hours. In accordance with DE-A 4337482, such acrylic copolymers A have been subjected to polymer-analogous reaction with the functional olefinically unsaturated monomers B in highly concentrated solution or in bulk at from 70 to 150° C. with an average residence time of in particular from 5 to 10 minutes, the ratio of the functional groups of the copolymer A to the functional groups of the monomer B being preferably 1:1. Here again, according to the examples, the polymer-analogous reaction took place in the presence of a reaction accelerator (a phosphine) and a phenothiazine as customary polymerization inhibitor (cf. also column 6 line 65 to column 7 line 3). WO 97/46 594 describes how corresponding polymer-analogous reactions may also be conducted at a temperature of from 150 to 200° C. for from 50 to 60 minutes in the absence of a reaction accelerator and without gelling by operating in the presence of appropriate amounts of an inhibitor (cf. page 1, last paragraph of text, and also claim 1) and with effective heat exchange, while avoiding the incidence of local overheating. Inhibitors mentioned include hydroquinone and its monoether, phenothiazine, aromatic diamines, and triphenyl phosphite.

It has now been found that radiation-curable, and especially UV-curable, binders of this kind are particularly advantageous in many applications and have improved optical properties and weathering stability by minimizing the amounts of low molecular mass, secondary constituents they contain, such as inhibitors or reaction accelerators or catalysts.

It is an object of the present invention to prepare radiation-curable binders having pendant olefinically unsaturated C═C double bonds by polymer-analogous reaction of epoxy-functional acrylic copolymers and carboxyl-containing monomers, with a reduced content of low molecular mass, secondary constituents and thus with improved optical properties, which may be used with particular advantage as transparent, undiscolored, film forming binders for topcoats and clearcoats, for example.

We have found that this object is achieved by means of radiation-curable binders of low additive content obtainable by polymer-analogous reaction of

A) epoxy-functional (meth)acrylate copolymers with

B) at least one olefinically unsaturated aliphatic C₃-C₆ monocarboxylic acid, the polymer-analogous reaction of the copolymers A taking place

a) with at least 2, preferably with from 2 to 3 equivalents of the carboxylic acid B, based on the amount of epoxide groups of the copolymer A,

b) in the absence of any significant amount of reaction accelerators and polymerization inhibitors,

c) in a continuously operated reactor,

d) with essentially no solvent and preferably in bulk,

e) at a reaction temperature of from 130 to 170° C.,

f) with a degree of conversion of the epoxide groups of the copolymer A of at least 90% and preferably at least 95%,

g) the average residence time established being as short as possible but sufficient to achieve the desired degree of conversion f), and not exceeding a maximum average residence time which shortens in proportion to the increasing reaction temperature e) and amounts to 32 minutes at 130° C., 25 minutes at 140° C., 20 minutes at 150° C., 17 minutes at 160° C., and 13 minutes at 170° C.

It was surprising that the reaction products of the invention could be prepared essentially without solvent, at high reaction temperatures in the absence of customary inhibitors, for example, phenol compounds or phenothiazines, and in the absence of reaction accelerators or catalysts for the epoxide-carboxylic acid reaction, and with a high degree of conversion of the epoxide groups without the occurrence during the reaction of crosslinking and/or without a sharp increase in the molecular weight and/or viscosity of the polymer. The reduction achieved in the amount of low molecular mass, secondary constituents in the product leads to improved performance properties of the product, such as improved optical properties.

Suitable epoxy-functional (meth)acrylate copolymers A for the preparation of the polymer-analogous reaction products of the invention include, in particular, copolymers of acrylic esters and/or methacrylic esters which contain, in copolymerized form, from 40 to 95% by weight of acrylic and/or methacrylic ester and from 5 to 60, and in particular from 10 to 35, % by weight of a copolymerizable olefinically unsaturated monomer containing an epoxide group. Suitable esters of acrylic and/or methacrylic acid are, in particular, alkyl esters having 1 to 10 carbon atoms in the alkyl radical, such as methyl methacrylate, methyl acrylate, ethyl acrylate, ethyl methacrylate, isopropyl acrylate, butyl acrylates and methacrylates, such as n-butyl acrylate and n-butyl methacrylate, 2-ethylhexyl acrylate, 2-ethylhexyl methacrylate, and n-decyl acrylate. However, the copolymers can also contain, in copolymerized form, other copolymerizable olefinically unsaturated monomers, examples being styrene, α-methylstyrene, vinyl esters, such as vinyl acetate, or (meth)acrylonitrile, provided the other monomers contain no functional groups which significantly adversely affect the polymer-analogous reaction between the epoxy groups and carboxyl groups. Examples of suitable copolymers of olefinically unsaturated monomers containing an epoxide group are, in particular, olefinically unsaturated glycidyl esters and glycidyl ethers, such as allyl glycidyl ether and glycidyl crotonate, and preferably glycidyl methacrylate and glycidyl acrylate.

By means of appropriate selection of monomers which form “hard” homopolymers (Tg>20° C.) and monomers which form “soft” (Tg<0° C.) homopolymers, and of the molecular weights it is possible in a manner known per se to prepare copolymers A that are suitable for the intended use of the polymer-analogous reaction products as coating materials. Suitable monomers which form hard and soft homopolymers are described, for example, in Ullmann's Encyclopedia of Industrial Chemistry, 5th Ed., Vol.A21, p.169 (1992). The copolymers A preferably have an average molecular weight Mₙ of from approximately 1 500 to 10 000 and in particular from approximately 1 500 to 6 000 and a polydispersity M_{w}/Mₙ of less than 4 and in particular less than 3. The preparation of such copolymers A is known per se (cf. e.g., EP-B 0156170 or DE-A 4 337 481) and takes place preferably by free-radical copolymerization in bulk or solution at temperatures above 150° C. in a short polymerization time (<90, preferably <25 minutes) to a conversion of approximately 80 to 90% and with subsequent degassing of the copolymer A.

Carboxyl-containing monomers B for the polymer-analogous reaction are olefinically unsaturated aliphatic C₃-C₆ monocarboxylic acids, such as acrylic acid, methacrylic acid and/or crotonic acid. Preference is given to reaction of the copolymers A with acrylic acid and/or methacrylic acid. In order to prevent the formation of crosslinks and in order to achieve a high degree of conversion of the epoxide groups of the copolymer A in the polymer-analogous reaction, it has proven essential to react the copolymer A with a significant molar excess of the carboxyl groups of the monomer B in relation to the amount of the epoxide groups of the copolymer A. Accordingly, the copolymer is reacted with at least 2, and, preferably, with from 2 to 3 equivalents of the unsaturated carboxylic acid B, based on the amount of epoxide groups of the copolymer A.

It is known that, in the case of polymer-analogous reaction of a copolymer with a functional polymerizable monomer, there is a risk of the monomer polymerizing itself and/or of the crosslinked polymers forming with inclusion of the pendant unsaturated groups of the copolymer produced by the reaction. As is known, the probability of polymerization and crosslinking goes up as the reaction time, and in particular the reaction temperature, increase. For this reason, the patent application WO 97/46594 cited above as state of the art specifies as an absolutely necessary measure the addition of appropriate amounts of polymerization inhibitors (p. 1, last paragraph). As is known, many monomers polymerize even at from 80 to 100° C. It was therefore unexpected that the uncrosslinked reaction products of the invention may be prepared at reaction temperatures of from 130 to 170° C. and in the absence of significant amounts of reaction accelerators for the epoxide-carboxylic acid reaction and in the absence of significant amounts of polymerization inhibitors. A significant amount of a reaction accelerator in this context is understood as an effective amount of the latter for reaction acceleration. A significant amount of a polymerization inhibitor is regarded as an inhibitively effective amount of a polymerization inhibitor which on preparation or application in the present manner and amount leads to a discoloration of the polymer-analogous reaction product. The term “in the absence of any significant amount” generally denotes working in the presence of less than 25 ppm by weight, usually less than 20 ppm by weight, in particular less than 10 ppm by weight, of reaction accelerator or polymerization inhibitor, based on the copolymer A. Preferably no reaction accelerators and no polymerization inhibitors at all are added to the reaction mixture. This makes it possible to reduce the amount of unwanted, low molecular mass secondary products in the radiation-curable polymers. In view of the fact that many customary polymerization inhibitors such as hydroquinone compounds or phenothiazine discolor the products thus stabilized in the course of preparation or use, the fact that the reaction product contains no significant amount of such inhibitors permits the preparation and use of transparent, undiscolored products, which represents a significant advantage of the reaction products of the invention when employed, for example, as binders for clearcoats.

The polymer-analogous reaction takes place substantially in the absence of solvent, or in bulk, at a temperature of from 130 to 170° C. and, preferably, at from 130 to 160° C., with effective mixing of the reactants in a continuously operated reactor at a set average residence time which is set as short as possible but sufficient for achieving the degree of conversion of the epoxide groups of at least 90%, preferably at least 95%, under the prevailing conditions. The average residence time is dependent on the chosen reaction temperature of from 130 to 170° C. It must not exceed a maximum average residence time which shortens with increasing temperature and which at 130° C. is 32 minutes, at 140° C. 25 minutes, at 150° C. 20 minutes, at 160° C. 17 minutes, and at 170° C. 13 minutes. Maximum average residence times for reaction temperatures which lie between the stated reaction temperatures may most easily be determined by graphic means, from the curve obtained after plotting the stated time/reaction temperature values as a function of the maximum average residence time from the reaction temperature. The extent to which the average residence time to be set at a given reaction temperature may be shorter than the maximum time while nevertheless achieving the desired degree of conversion f) at from 90 to 99% of the epoxide groups may then be determined in a few preliminary tests. For instance, with a reaction in the extruder at from 140 to 160° C., advantageous average residence times sufficient for obtaining a degree of conversion f) of at least 95% were from 10 to 15 minutes.

The polymer-analogous reaction takes place essentially without solvent in known continuously operated reactors such as stirred tanks, for example. Advantageously, there may also be mixers downstream of the reactors. It is further judicious to follow the reactors for reacting the monomers B with the copolymer A by reactors in which the reaction product may be substantially freed from volatile constituents by the application of a subatmospheric pressure. With the high viscosity of the reaction mixture, it has proven particularly advantageous to use extruders and especially multi-screw extruders as the reactors, since they permit very good mixing of the reaction mixture at the reaction temperature in a very short time. An overview of designs of continuous reactors and criteria for their selection is given, for example, by H. Thiele and H. D. Zettler “Kontinuierliche Reaktionsmaschinen” in “Polymerreaktionen und reaktives Aufbereiten in kontinuierlichen Maschinen”, VDI-Verlag, Dusseldorf 1988, and H. Herrmann “Schneckenmaschinen in der Verfahrenstechnik”, Springer-Verlag, Berlin-Heidelberg-New York 1972. Highly suitable for the polymer-analogous reaction of the copolymers A in bulk with the reactive monomers are multiscrew extruders and, in particular, twin-screw screw machines with corotating screws, such as the twin-screw ZSK screw extruder from Werner & Pfleiderer. In such extruders, after a first feed and conveying zone, the copolymer A, heated to approximately reaction temperature and melted, may be mixed with the reactive monomer B in a second zone of the extruder. In a third zone of the extruder or in a downstream second extruder, such as a corotating twin-screw extruder (e.g., of type ZSK 58 from Werner & Pfleiderer), the reacted mass can then advantageously be devolatilized, i.e., freed substantially from volatile constituents by application of a subatmospheric pressure, it being possible for the temperature in the devolatilizing zone to be the same as or different than the reaction temperature, depending on the subatmospheric pressure applied. Subsequently, the mass, which is generally in the form of a melt, is discharged. This may be followed, for example, by further processing to give powders of appropriate particle diameter. The reaction products of the invention have glass transition temperatures in the range, in particular, of from −20 to +70° C. and are readily film-forming. They feature improved optical properties, are largely transparent and undiscolored, exhibit good curing properties, and possess good weathering stability in the cured state. Owing to the reduced level of additives, i.e. low molecular mass byproducts, they are particularly suitable for use as packaging varnishes and, in general, for use as widely applicable clearcoat materials, powder coating materials, and for powder slurries.

The examples which follow are intended to illustrate the invention but without restricting it. Unless specified otherwise, parts and percentages are by weight. The epoxide value was determined in accordance with DIN 53188 (cf. also Ullmann: Encyclopädie der technischen Chemie, Vol. 8, 3rd edition 1957, p.436). The solids content was determined gravimetrically by drying at 200° C. for 20 minutes. The average molecular weights Mₙ, M_{w} and the polydispersity M_{w}/Mₙ were determined by gel permeation chromatography using polystyrene as standard. The methods are described in Analytiker-Taschenbuch Volume 4, pp.433-442, Berlin 1984 and also in “Modern Size Exclusion Liquid Chromatography, Practice of Gel Permeation Chromatography”, Wiley New York 1979. The reported viscosities were determined using a plate/plate viscometer (C.Gerth, Rheometrie, Ullmanns Enzyklopadie der Techn. Chemie, Volume 19, pages 17-18). The average residence time of the reaction mixture for polymer-analogous reaction in the reaction temperature range in the continuously operated reactor does not generally include the residence time in the devolatilizing zone. The average residence time was determined by adding titanium dioxide granules which diffusely reflect a sensor light (infrared light), the granules being added to the reaction mixture at the reactor entry. The sensor intensity, modified by the reflection, was detected by a receiver at the end of the reactor (generally before the devolatilizing process) and so gave a clearly perceptible signal of the average residence time of the reaction mixture and, respectively, of the polymer in the reactor. The acid number (mg of KOH per g of polymer) was determined by titrating the sample, dissolved in acetone, with methanolic potassium hydroxide solution.

### EXAMPLE 1

An epoxy-functional copolymer A containing, in copolymerized form, 23% of glycidyl acrylate, 7% of 2-ethylhexyl acrylate, 9% of tert-butylcyclohexyl acrylate, 47% of methyl methacrylate and 14% of styrene and having an average molecular weight Mₙ of 2 900 g/mol and a polydispersity M_{w}/Mₙ of 2.6 was reacted with 2 equivalents of acrylic acid, based on the amount of epoxide groups in the copolymer A, in a twin-screw ZSK extruder from Werner & Pfleiderer with corotating screws at 140° C. in the absence of a reaction accelerator for the epoxide-carboxylic acid reaction and in the absence of a polymerization inhibitor, to a degree of conversion of the epoxide groups of the copolymer A of approximately 98%. The average residence time was approximately 15 minutes. The reaction product was subsequently devolatilized in a downstream corotating twin-screw extruder from Werner & Pfleiderer at a temperature of 140° C. by application of a subatmospheric pressure. The result was a highly transparent, uncrosslinked and undiscolored reaction product which was particularly suitable for the preparation of a UV-curable powder coating material.

Comparative Experiment 1

Example 1 was repeated but, prior to the reaction, 2% of tetramethylammonium bromide as a reaction accelerator and 0.02% of phenothiazine as polymerization inhibitor were added to the amount of acrylic acid, the percentages being based on the amount of copolymer A. The reaction took place likewise at 140° C. with an average residence time of approximately 15 minutes. Following devolatilization, the reaction product showed a degree of conversion of the epoxide groups of the copolymer of 98%, but the resulting reaction product had a reddish coloration.

Coomparative Experiment 2

Example 1 was repeated but the reaction of the copolymer A with the reactive monomer was conducted in the absence of a reaction accelerator and in the absence of a polymerization inhibitor at 120° C. with an average residence time for the reaction of approximately 15 minutes. The result was an undiscolored reaction product which showed a degree of conversion of the epoxide groups of the copolymer A of 87%. The high residual epoxide group content of the reaction product threatened the stability of its performance properties.

Comparative Experiment 3

Comparative experiment 1 was repeated but the reaction temperature was 120° C. As indicated, the reaction took place in the presence of reaction accelerator and polymerization inhibitor. With an average residence time of approximately 15 minutes, a degree of conversion of the epoxide groups of the copolymer A of 98% was achieved, but the resulting reaction product had a reddish discoloration.

### EXAMPLE 3

Example 1 was repeated in the absence of a reaction accelerator and polymerization inhibitor, but at a reaction temperature of 150° C. The average residence time was 12 minutes. The result was an uncrosslinked, transparent and undiscolored reaction product whose average molecular weight Mₙ was 3 250, i.e., only a little higher than that of the copolymer A (cf. Example 1). The degree of conversion of the epoxide groups of the copolymer A was 98%.

We claim:

1. An uncrosslinked, radiation-curable binder of low additive content, obtained by polymer-analogous reaction of
A) an epoxy-functional (meth)acrylate copolymer A with
B) at least one olefinically unsaturated aliphatic C₃-C₆ monocarboxylic acid, the polymer-analogous reaction of the copolymer A taking place
a) with at least 2 equivalents of the carboxylic acid B, based on the epoxide groups of the copolymer A,
b) in the absence of any significant amount of a reaction accelerator for the epoxide-carboxylic acid reaction and in the absence of any significant amount of a polymerization inhibitor,
c) in a continuously operated reactor,
d) with essentially no solvent,
e) at a reaction temperature of from 130 to 170° C., and
f) with a degree of conversion of the epoxide groups of the copolymer A of at least 90%,
g) the average residence time established being sufficient for achieving the chosen degree of conversion f), and not exceeding a maximum average residence time which shortens with the increasing reaction temperature e) and amounts to 32 minutes at 130° C., 25 minutes at 140° C., 20 minutes at 150° C., 17 minutes at 160° C., and 13 minutes at 170° C.

2. A radiation-curable binder of low additive content as claimed in claim 1, wherein the degree of conversion is at least 95%.

3. A radiation-curable binder as claimed in claim 1, wherein the continuously operated reactor is an extruder.

4. A radiation-curable binder of low additive content as claimed in claim 3, wherein the reaction temperature in the extruder is from 140 to 160° C., the degree of conversion f) is at least 95% and the average residence time is from about 10 to 15 minutes.

5. A radiation-curable binder of low additive content as claimed in claim 1, wherein the copolymer A is an alkyl (meth)acrylate copolymer containing, in copolymerized form, from 5 to 60% by weight of a comonomer containing reactive epoxide groups based on the overall weight of the copolymer.

6. A radiation-curable binder of low additive content as claimed in claim 1, which is transparent and undiscolored.

7. A process for preparing a radiation-curable binder of low additive content as claimed in claim 1 by polymer-analogous reaction of
A) a copolymer containing reactive epoxide groups with
B) at least one olefinically unsaturated aliphatic C₃-C₆ monocarboxylic acid, the polymer-analogous reaction of the copolymer A taking place
a) with at least 2 equivalents of the carboxylic acid B, based on the epoxide groups of the copolymer A,
b) in the absence of any significant amount of a reaction accelerator for the epoxide-carboxylic acid reaction and in the absence of any significant amount of a polymerization inhibitor,
c) in a continuously operated reactor,
d) with essentially no solvent,
e) at a reaction temperature of from 130 to 170° C., and
f) with a degree of conversion of the epoxide groups of the copolymer A of at least 90%,
g) the average residence time established being sufficient for achieving the chosen degree of conversion f), and not exceeding a maximum average residence time which shortens with the increasing reaction temperature e) and amounts to 32 minutes at 130° C., 25 minutes at 140° C., 20 minutes at 150° C., 17 minutes at 160° C., and 13 minutes at 170° C.

8. A clearcoat material, powder coating material, packaging varnish or powder slurry comprising a binder as claimed in claim 1.
